(19) United States
(12) Patent Application Publication
(10) Pub. No.: US 2023/0304241 A1
(43) Pub. Date: Sep. 28, 2023

(54) Curb Cleaner Device

(71) Applicant: Nicholas Moore, Loganville, GA (US)

(72) Inventor: Nicholas Moore, Loganville, GA (US)

(21) Appl. No.: 17/704,940

(22) Filed: Mar. 25, 2022

(51) Int. Cl. E01H 3/02; B08B 3/02; B05B 1/20; B05B 13/00; B05B 13/04

(52) U.S. Cl. CPC E01H 3/02; B05B 1/205; B05B 13/005; B05B 13/0415; B08B 3/024

(57) ABSTRACT

The present invention provides a curb cleaning system having a main body configured in an L shape, an adjustable arm attached to the main body, a guide wheel attached to said adjustable arm, at least two solution nozzles each positioned on complimentary surfaces of said L shape, and a wand attached to the adjustable arm.

### BACKGROUND OF THE INVENTION

Persons that are familiar with cleaning devices used in water or pressure cleaning are familiar with a plurality of attachments. In general, these attachments are configured to make a particular task more effective. There happens to be one very common cleaning task for which there is no truly suitable device.

It is very common when cleaning curves that the devices require significant repetition due to the need to reach services with different orientations.

Users are typically required to separately clean each surface.

The present invention addresses this issue.

### SUMMARY OF THE INVENTION

In one embodiment, the invention functions as an attachment for the pressure wash wand. There are nozzles located on the sides and top of the unit. The nozzles on the sides of the unit will clean the sides of the curb while the nozzles located on the top of the unit will clean the tops of the curb. The side and top nozzles will function at the same time so the entire curb is cleaned at one time instead of cleaning the sides and top separately. Due to the entire curb being cleaned at the same time, it will save the user time. There will also be a wheel on the left bottom and right top of the unit that allows the user to push the curb cleaner easily alongside the curb.

The curb cleaner attachment forms to a curb and allows the user to clean the top and sides of curbs in one motion.

In one embodiment, the invention is a curb cleaning system comprising:
a main body configured in an L shape;
an adjustable arm attached to said main body;
a guide wheel attached to said adjustable arm;
at least two solution nozzles each positioned on complimentary surfaces of said L shape, said nozzles configured to deliver solution simultaneously to each of a vertical rise curb surface and adjacent upper horizontal curb surface; and
a wand attached to said adjustable arm.

In one embodiment, the main body further includes a solution inlet.

In one embodiment, the main body further includes a solution inlet configured to receive pressurized solution in the range from between 750 - 30,000 psi.

In one embodiment, the solution inlet is operatively associated with each of said at least two solution nozzles.

In one embodiment, the two solution nozzles is configured to provide an outlet of pressurized solution in the range from between 750 - 30,000 psi.

In one embodiment, each adjustable arm is pivotably attached to said main body at a pin mount by a pivot pin.

In one embodiment, the wand is permanently attached to said adjustable arms.

In one embodiment, the wand is removably attached to said adjustable arm.

In one embodiment, the invention is a curb cleaning system consisting of:
a main body configured in an L shape;
two adjustable arms attached to said main body;
an upper guide wheel and a lower guide wheel, each attached respectively to said adjustable arms, said two adjustable arms being a first adjustable arm attached to said upper guide wheel and a second adjustable arm attached to said lower guide wheel;
at least two solution nozzles each positioned on complimentary surfaces of said L shape, said two solution nozzles configured to deliver solution to an upper curb surface and a lower curb surface as described herein, said surfaces being a vertical rise surface and adjacent upper horizontal curb surface; and
a wand attached to said adjustable arm, said main body further includes a solution inlet configured to receive pressurized solution in the range from between 750 - 30,000 psi and said solution inlet is operatively associated with each of said at least two solution nozzles; wherein said at least two solution nozzles is configured to provide an outlet of pressurized solution in the range from between 750 - 30,000 psi;
each of said adjustable arms is pivotably attached to said main body at a pin mount by a pivot pin.

### BRIEF DESCRIPTION OF THE SEVERAL VIEWS OF THE DRAWINGS

FIG. 1 is a partial cut away side view according to one embodiments of the present invention.

FIG. 2 is a front view according to one embodiments of the present invention.

FIG. 3 is a sectional view along section lines A-A from FIG. 2.

FIG. 4 is a front view of an adjustment plate according to one embodiments of the present invention.

FIG. 5 is a side view of an adjustment plate according to one embodiments of the present invention.

FIG. 6 is a front view according to one embodiments of the present invention.

### DETAILED DESCRIPTION OF THE PREFERRED EMBODIMENTS

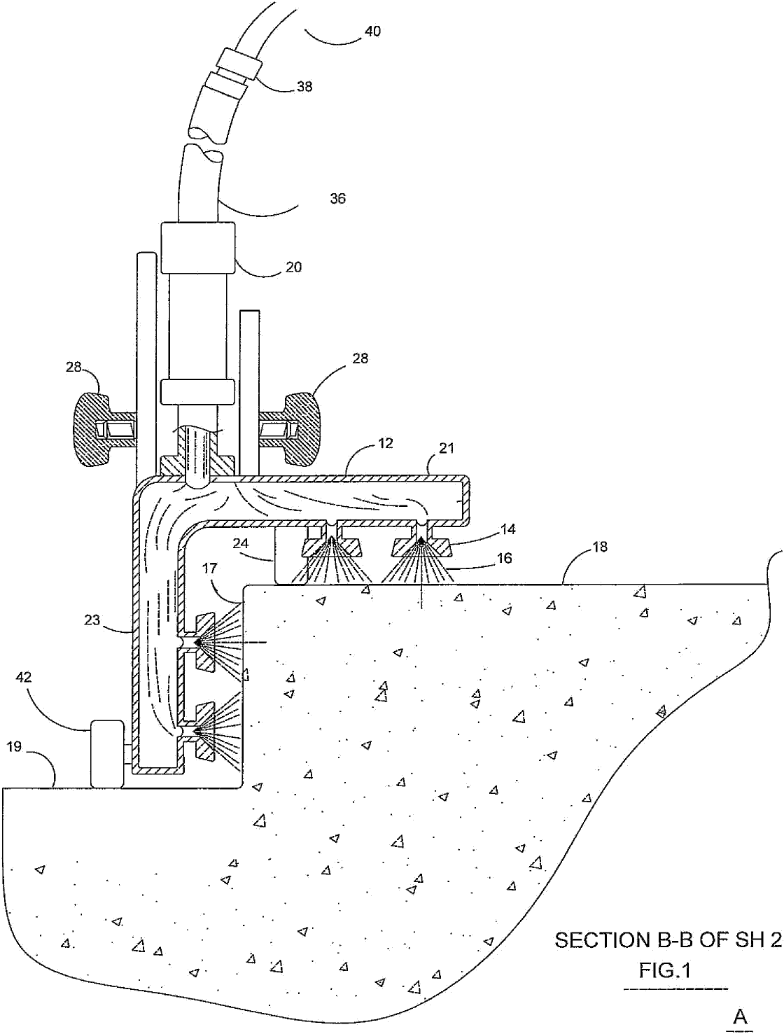

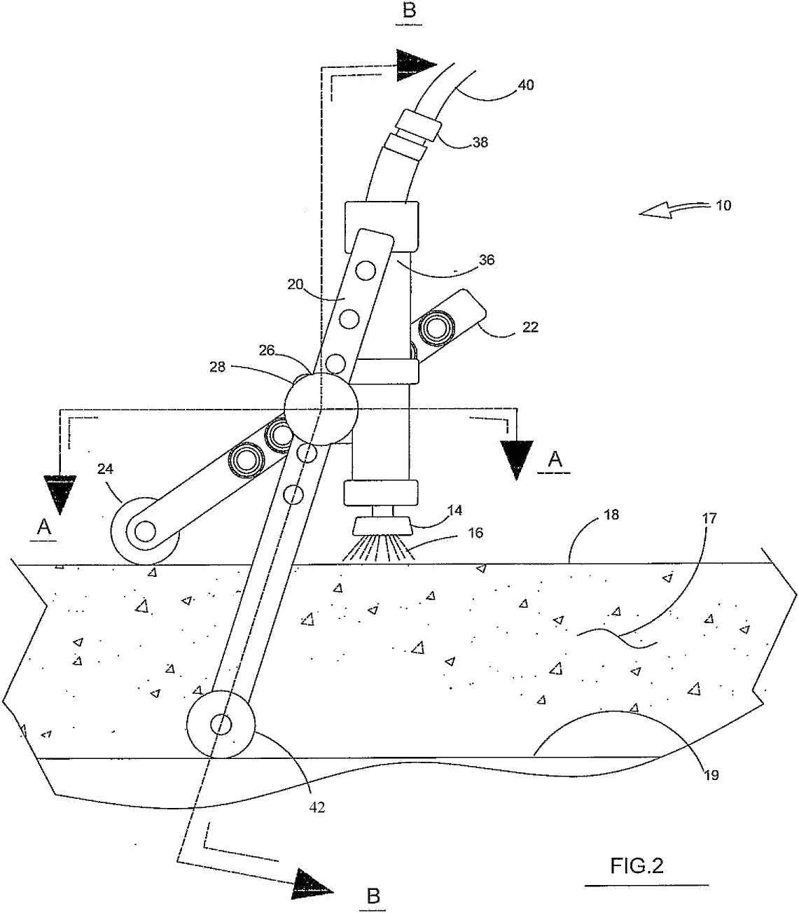

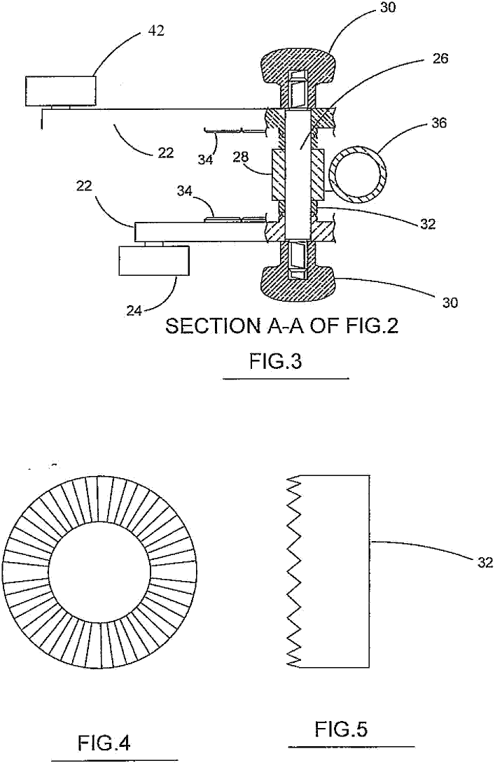

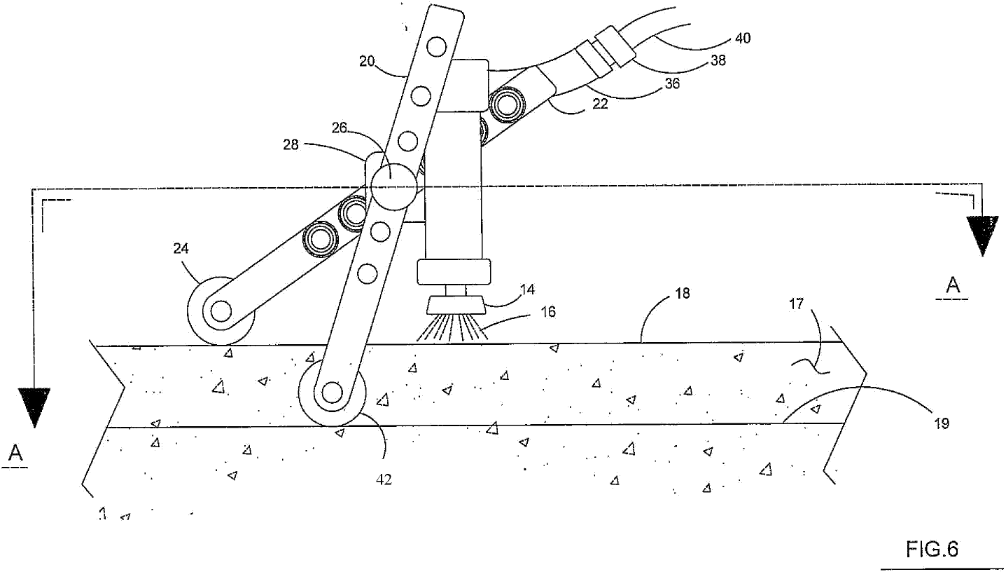

As generally understood by the figures, System 10 includes main body 12. As demonstrated in the drawings, main body 12 is constructed and arrange substantially as an “L” shape. The body has a horizontal section 21 and vertical section 23. Nozzles 14 are along the main body 12 as shown in FIG. 1. In use, an appropriate cleaning solution 16 exits nozzles 14 and allows the user to simultaneously clean horizontal 18 and vertical surfaces 19 of a curb. Wand 20 is connected to adjustable arm 22 in which upper guide wheel 24 is attached. Adjustable on 22 is preferably attached with a pivot pin 26 and to pivot pin mount 28. Similarly configured is lower guide wheel 42. Upper guide wheel 24 is configured to move upon upper horizontal curb surface 18. Lower guide wheel 42 is configured to move upon lower curb surface 19. The terms upper and lower are understood as common terms whereby two horizontally oriented surfaces of a curb are so positioned as shown in the drawings and a vertical rise surface 17 is positioned therebetween.

Pin locking nut 30 is utilized as needed to secure adjustable arm 22 into a fixed position.

The system further includes first angular adjustment plate 32 second angle adjustment plates 34 each secured two adjustable arm 22. Each angular adjustment plate allows the top wheel to be adjusted so it runs smoothly along the top of the curb. The angular adjustment plate is in the pivot area of the adjuster to adjust the length and depth of the top wheel drag behind. It acts as a washer for smooth adjustment.

One adapter 36 has a fixed to its proximal end quick disconnect 38 which is subsequently fixed to hose 40.

In use, how is 40 is connected to a water source that provides water and / or a desired cleaning solution to a system 10. How is 40 is connected utilizing a quick connect/disconnect to wand 38. Once the connection is made, a user will initiate the flow of water and or desire cleaning solution through holes 40 that will flow through system 10. A user will position main body 12 along the curb such that each of the horizontal and vertical spray nozzles 14 are positioned above horizontal and vertical surfaces of a curb to be cleaned. Guide wheel 24 assist the user moving system 10 along the curb in order to effectively clean each of the horizontal and vertical curb surfaces.

In providing a system 10 of the present invention the configuration of the main body assists a user in effectively cleaning multiple surfaces being horizontal and vertical curb surfaces requiring excessive motions.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

What is claimed:

1. A curb cleaning system comprising:
a main body configured in an L shape;
an adjustable arm attached to said main body;
a guide wheel attached to said adjustable arm;
at least two solution nozzles each positioned on complimentary surfaces of said L shape, said nozzles configured to deliver solution simultaneously to each of a vertical rise curb surface and adjacent upper horizontal curb surface; and
a wand attached to said adjustable arm.

2. The curb cleaning system of claim 1, wherein said main body further includes a solution inlet.

3. The curb cleaning system of claim 1, wherein said main body further includes a solution inlet configured to receive pressurized solution in the range from between 750 - 30,000 psi.

4. The curb cleaning system of claim 2, wherein said solution inlet is operatively associated with each of said at least two solution nozzles.

5. The curb cleaning system of claim 2, wherein said at least two solution nozzles is configured to provide an outlet of pressurized solution in the range from between 750 - 30,000 psi.

6. The curb cleaning system of claim 1, wherein said adjustable arm is pivotably attached to said main body at a pin mount by a pivot pin.

7. The curb cleaning system of claim 1, wherein said wand is permanently attached to said adjustable arm.

8. The curb cleaning system of claim 1, wherein said wand is removably attached to said adjustable arm.
